(19) United States
(12) Patent Application Publication
(10) Pub. No.: US 2016/0208151 A1
(43) Pub. Date: Jul. 21, 2016

(54) COMBINATION OF RTV-1 SILICONE FORMULATION AND ACCELERATOR WITH ENHANCED CURE CHARACTERISTICS

(71) Applicant: SIKA TECHNOLOGY AG, Baar (CH)

(72) Inventors: Manuel FRIEDEL, Zürich (CH); André SAVOY, Rudolfstetten (CH); Andrea MÜLLER, Ammerwil (CH)

(73) Assignee: SIKA TECHNOLOGY AG, Baar (CH)

(21) Appl. No.: 15/023,058

(22) PCT Filed: Sep. 18, 2014
(86) PCT No.: PCT/EP2014/069891

§ 371 Date: Mar. 18, 2016

(30) Foreign Application Priority Data
Sep. 20, 2013 (EP) 13185434.1

(51) Int. Cl. C09J 183/04; B29C 65/48

(52) U.S. Cl. CPC C09J 183/04; B29C 65/48

(57) ABSTRACT

A two-component composition is described, comprising as component A) a one-component, moisture-curing silicone composition comprising a) at least one crosslinkable polydiorganosiloxane, b) at least one siloxane containing alkoxy groups as crosslinker, obtainable from the partial hydrolysis and condensation of one or more alkoxysilanes, at least one alkoxysilane being a trialkoxysilane or a tetraalkoxysilane, and the average degree of condensation of the siloxane containing alkoxy groups being at least 5, and c) at least one condensation catalyst, and as component B) an accelerator comprising water. The two-component composition makes a suitable adhesive or sealant. Addition of the aqueous accelerator to the silicone composition allows accelerated curing.

### TECHNICAL FIELD

The invention relates to a two-pack composition comprising a one-pack moisture-curing silicone composition and an accelerator, to a method for adhesively bonding or joining with the composition, and to the use thereof.

### PRIOR ART

Silicones are known compositions which have long been used as adhesives or sealants. Such silicones may take the form of one-pack or two-pack silicone formulations, and comprise as their principal components a polyorganosiloxane and a crosslinker. Distinctions are made between cold-crosslinking RTV silicones (RTV=room temperature vulcanizing or crosslinking) and hot-crosslinking HTV silicones (HTV=high temperature vulcanizing or crosslinking). One- and two-pack RTV silicones are also referred to as RTV 1 silicones and RTV 2 silicones, respectively.

RTV-1 silicones have been known for a long time. Likewise known is the fact that such formulations are able to cure on the basis of what is called neutral crosslinking. Conventionally, neutrally crosslinking systems released oxime compounds, whose odor is perceived as highly unpleasant. An alternative possibility is to formulate RTV-1 silicones with crosslinkers containing alkoxy groups. Elimination products of the crosslinking are then alcohols, whose odor is much less unpleasant. Crosslinkers generally used are monomeric silanes.

It is further known that the curing of RTV-1 silicones can be accelerated by addition of water. However, this is readily possible only for the systems described that release oximes.

EP-A1-2202276 describes a 2-pack silicone formulation, one of the components comprising water in dispersed form. In the specific embodiments, these silicone formulations require oxime-containing crosslinkers, which release foul-smelling oximes on curing.

DE-T2-60102746 describes silicone compositions based on OH-terminated polydiorganosiloxanes that comprise precipitated silica. The precipitated silica serves as a supplier of water, in order to accelerate the curing reaction. A disadvantage of the disclosure is that these formulations have to be formulated as RTV-2, i.e., 2-pack systems.

EP 1865029 A2 relates to crosslinkable compositions based on organosilicon compounds such as polydimethylsiloxanes, comprising finely divided metacarbonate and optionally a crosslinker and a curing accelerator. The crosslinker may be a monomeric silane or a partial hydrolyzate thereof. For the crosslinking of the composition, water can be added.

US 2013/102720 A1 describes a composition which is crosslinkable to an elastomer in the presence of water and which comprises a polyorganosiloxane, a siloxane composed of 2 to 10 siloxyl units, and optionally a condensation catalyst.

US 2012/065308 A1 relates to crosslinkable polymer compositions which comprise a silyl-containing polymer such as a polysiloxane, a crosslinker, an organometallic catalyst, and an acidic compound. In one embodiment the crosslinker may be a monomeric silane or a condensation product thereof having a degree of condensation of 2 to 10.

### DEPICTION OF THE INVENTION

It is an object of the present invention, therefore, to provide a one-pack moisture-curing silicone formulation which can be formulated without oxime, which cures only with release of alcohols, and whose curing reaction can be accelerated by the addition of water.

It has surprisingly been observed that for oxime-free silicone formulations as well, the curing reaction can be accelerated through addition of water if specific siloxanes comprising alkoxy groups are used as crosslinkers.

The invention accordingly provides a two-pack composition comprising as component A) a one-pack moisture-curing silicone composition comprising
a) at least one crosslinkable polydiorganosiloxane,
b) at least one siloxane comprising alkoxy groups, as crosslinker, obtainable from the partial hydrolysis and condensation of one or more alkoxysilanes, at least one alkoxysilane being a trialkoxysilane or a tetraalkoxysilane, and the average degree of condensation of the siloxane comprising alkoxy groups being at least 5, and
c) at least one condensation catalyst,

and as component B) an accelerator comprising water.

With the composition of the invention it is possible, by mixing the two components, to accelerate curing, without any need for the organofunctional ketoximosilanes that are otherwise customary as crosslinkers. The invention is elucidated comprehensively below.

### WAY OF PERFORMING THE INVENTION

The viscosities reported here can be determined in accordance with DIN 53018. The measurement may be made using an MCR101 cone/plate viscometer from Anton-Paar, Austria, using cone type CP 25-1 at 23° C. The reported viscosity values relate to a shear rate of 0.5 s⁻¹.

An alkoxysilane is a monomeric silane having at least one alkoxy group which is bonded on the Si atom. A trialkoxysilane and a tetraalkoxysilane are, respectively, a monomeric silane having three or four alkoxy groups bonded to the Si atom. The alkoxy group may be a C₁-C₆ alkoxy group, for example.

The two-pack composition consists of a component A) and a component B) as accelerator which comprises water. The composition comprises as component A) a one-pack moisture-curing silicone composition, more particularly an RTV-1 silicone. With such RTV-1 silicones, the cure is effected by contact with water, generally by contact with the atmospheric moisture in the air. Components A) and B) are present separately. Through the mixing of the components, customarily shortly before processing, the curing of component A) is accelerated.

Component A) comprises one or more crosslinkable polydiorganosiloxanes. Crosslinkable polydiorganosiloxanes of this kind are well known to the person skilled in the art. The crosslinkable polydiorganosiloxanes have functional groups, more particularly two or more functional groups, via which crosslinking is possible. These functional groups may be present in a side group or in an end group of the polydiorganosiloxane, with terminal functional groups being preferred. Polydiorganosiloxanes of this kind having terminal functional groups are also referred to as α,ω-functional polydiorganosiloxanes.

Functional groups are understood here to be groups which are able to react with the alkoxy groups of the crosslinker and, in so doing, to form a bond. The reaction between the functional group of the polydiorganosiloxane and the functional group of the crosslinker takes place preferably through a condensation reaction. In this reaction, byproducts such as water or alcohol are generally released.

Suitable functional groups are all those customarily used in the art. Preferred examples of such functional groups of the polydiorganosiloxane are hydroxyl groups and masked hydroxyl groups, more particularly masked hydroxyl groups bonded to an Si atom, these being preferably terminal groups. Masked hydroxyl groups are hydroxyl groups which are released in the curing operation, with elimination of a protective group, for example, commonly by hydrolysis.

Examples of masked hydroxyl groups are alkoxy groups and acetoxy groups. The crosslinkable polydiorganosiloxane preferably has masked hydroxyl groups, more particularly alkoxy groups. Examples of the functional groups are the examples of the radical R⁴ that are set out below for the formula (I). The polydiorganosiloxane has 1 to 3, preferably 1 or 2, such functional groups at each end, for example.

When hydroxyl-terminated polydiorganosiloxanes are used, the compounding of the silicone formulation is frequently difficult. Using polydiorganosiloxanes with masked hydroxyl end groups, such as alkoxy groups, makes compounding easier.

In principle the functional groups of the crosslinkable polydiorganosiloxane may also be oxime groups bonded to an Si atom, such as ketoximo groups. These ketoximo groups are likewise masked hydroxyl groups. Preferably, however, the crosslinkable polydiorganosiloxane does not have any oxime group.

The viscosity of the polydiorganosiloxanes may vary within wide ranges depending on the end use. The polydiorganosiloxane used in accordance with the invention may have at a temperature of 23° C., for example, a viscosity of 10 to 500000 mPa·s and preferably of 5000 to 400000 mPa·s.

The crosslinkable polydiorganosiloxane is preferably a linear polydiorganosiloxane, more particularly a polydiorganosiloxane of the formula (I)

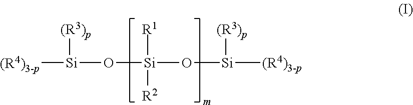

in which R¹, R² and R³ independently of one another are linear or branched, monovalent hydrocarbon radicals having 1 to 12 C atoms, which optionally have one or more heteroatoms, and optionally have one or more C—C multiple bonds and/or optionally have cycloaliphatic and/or aromatic moieties,

R⁴ independently at each occurrence is a hydroxyl group or a blocked hydroxyl group, preferably an alkoxy group or acetoxy group, R⁴ preferably being an alkoxy group,

the index p is a value of 0, 1 or 2,

and the index m is selected such that at a temperature of 23° C. the polydiorganosiloxane has a viscosity of 10 to 500000 mPa·s, preferably of 5000 to 400000 mPa·s.

In the formula (I) the radicals R¹ and R² independently of one another are preferably selected from alkyl groups having 1 to 5, more particularly having 1 to 3, C atoms, such as propyl, ethyl, and methyl, with methyl being particularly preferred, and optionally some of the alkyl groups, more particularly methyl, may be replaced by other groups such as vinyl, phenyl, or 3,3,3-trifluoropropyl. In the formula (I) the radical R³, if present, independently at each occurrence is preferably selected from phenyl, vinyl, or methyl groups.

R⁴ in the formula (I) is preferably hydroxyl, alkoxy, or acetoxy, more particularly alkoxy. Examples of the alkoxy group for the radical R⁴ in the formula (I) are C₁-C₆ alkoxy groups, with methoxy, ethoxy, and propoxy being particularly preferred.

The index m in the formula (I) is selected such that the polydiorganosiloxane has the viscosity indicated above. The index m in the formula (I) may be situated for example in the range from 10 to 10000 and preferably 100 to 1500.

The crosslinkable polydiorganosiloxane is preferably a crosslinkable polydimethylsiloxane. Crosslinkable polydiorganosiloxanes employed with preference are hydroxyl-, alkoxy-, or acetoxy-terminated linear polydiorganosiloxanes, more preferably alkoxy-terminated linear polydiorganosiloxanes (α,ω-alkoxy-functional polydiorganosiloxanes), the polydiorganosiloxane preferably being a polydimethylsiloxane. The hydroxyl-, alkoxy-, or acetoxy-terminated linear polydiorganosiloxanes, more particularly polydimethylsiloxanes, preferably at 23° C. have a viscosity of 5000 to 400000 mPa·s. As elucidated above, polydimethylsiloxanes of this kind may be modified in accordance with the prior art through partial incorporation of other organic groups instead of methyl.

Component A) further comprises at least one siloxane comprising alkoxy groups, as crosslinker, which is obtainable from the partial hydrolysis and condensation of one or more alkoxysilanes, at least one alkoxysilane being a trialkoxysilane or a tetraalkoxysilane, and the average degree of condensation of the siloxane comprising alkoxy groups being at least 5.

Monomeric silanes such as alkoxysilanes are known to be crosslinkers for polydiorganosiloxanes. In accordance with the invention a siloxane comprising alkoxy groups is used as crosslinker. The siloxane is obtainable by partial hydrolysis and condensation of one or more alkoxysilanes, at least one alkoxysilane being a trialkoxysilane or a tetraalkoxysilane, preferably a trialkoxysilane. The siloxane is therefore a condensation product of the stated monomeric alkoxysilanes that comprises alkoxy groups.

The hydrolysis and condensation reactions of alkoxysilanes are known to the person skilled in the art and may be represented schematically as follows.

≡Si—OR+H₂O→≡Si—OH+ROH (1)

≡Si—OH+HO—Si≡→≡Si—O—Si≡+H₂O (2)

On addition of water, and optionally with the assistance of a catalyst, alkoxy groups of the silanes undergo hydrolysis to form silanol groups (Si—OH) on the silane, and an alcohol (step 1). The silanols are generally unstable and undergo spontaneous condensation, forming siloxane bonds (—Si—O—Si—), and so siloxanes are formed (step 2). Whether the silane has more than one alkoxy group, more highly condensed systems may be formed. In the case of partial hydrolysis, only some of the alkoxy groups undergo hydrolysis and condensation.

Mono-, di-, tri-, or tetraalkoxysilanes or mixtures thereof may be used for the partial hydrolysis and condensation, with at least one alkoxysilane being a tri- or tetraalkoxysilane. Depending on the alkoxysilanes used and on the reaction regime, more particularly on the amount of water added, it is possible to adjust the degree of condensation and the fraction of alkoxy groups remaining in the siloxane formed. The alkoxysilanes may have nonhydrolyzable groups bonded on the Si atom, more particularly monovalent hydrocarbon radicals, which optionally have one or more functional groups, these nonhydrolyzable groups remaining in the siloxane formed. The alcohol byproduct formed may be removed, by evaporation under reduced pressure, for example. Siloxanes formed therefrom and comprising alkoxy groups are known and are available commercially.

The siloxane comprising alkoxy groups is obtainable, for example, from the partial hydrolysis and condensation of one or more alkoxysilanes of the formula (II)

R_{q}SiX_{4-q} (II)

in which R independently at each occurrence is a nonhydrolyzable monovalent hydrocarbon radical which optionally has one or more functional groups, X independently at each occurrence is an alkoxy group, and q is 0, 1, 2 or 3, at least one alkoxysilane being an alkoxysilane of the formula (II) with q=0 or 1, preferably 1. For the partial hydrolysis and condensation, preference is given to using one or more alkoxysilanes of the formula (II) with q 0 or 1, preferably 1.

Examples of suitable alkoxy groups for the radical X in the formula (II) are, independently of one another, C₁-C₆ alkoxy groups, preferably methoxy, ethoxy, propoxy, or butoxy groups, and more preferably methoxy groups and ethoxy groups.

The radical R in the formula (II), especially for alkoxysilanes of the formula (II) with q=1, may be, for example, a linear or branched, monovalent hydrocarbon radical having 1 to 12 C atoms, which optionally in addition has one or more functional groups. Examples of suitable radicals R in the formula (II), especially for alkoxysilanes of the formula (II) with q=1, are, independently of one another, alkyl groups having 1 to 6 C atoms, preferably methyl, ethyl, propyl, or butyl, alkenyl groups having 1 to 6 C atoms, preferably vinyl, aryl groups, preferably phenyl, cycloalkyl groups, such as cyclohexyl, aralkyl groups, or alkaryl groups, with methyl, n-propyl, vinyl, phenyl, 2-aminoethyl-3-aminopropyl, 3-glycidyloxypropyl, and 3-mercaptopropyl being particularly preferred.

The radical R in the formula (II), especially for alkoxysilanes of the formula (II) with q=1, may optionally in addition have one or more functional groups on the hydrocarbon radical having 1 to 12 C atoms, it being possible for the hydrocarbon radical to be one of the aforementioned examples such as alkyl, alkenyl, aryl, cycloalkyl, alkaryl, or arylalkyl, and particularly preferred as hydrocarbon radical being alkyl groups having 1 to 6 C atoms, preferably methyl, ethyl, or propyl. Suitable functional groups are, for example, halogen, such as chloro, hydroxyl, alkoxy, amino, e.g., NH₂, NHR, or NR₂, in which case R independently at each occurrence is alkyl, aryl, or cycloalkyl, and mercapto, glycidyloxy, methacryloyloxy, acryloyloxy, and carbamato. There may also be two or more functional groups in the radical R.

Specific examples of alkoxysilanes of the formula (II) are methyltrimethoxysilane, chloromethyltrimethoxysilane, ethyltrimethoxysilane, propyltrimethoxysilane, vinyltrimethoxysilane, phenyltrimethoxysilane, 3-mercaptopropyltrimethoxysilane, 3-aminopropyltrimethoxysilane, 3-methacryloyloxypropyltrimethoxysilane, 3-glycidyloxypropyltrimethoxysilane, 2-aminoethyl-3-aminopropyltrimethoxysilane, N-(n-butyl)-3-aminopropyltrimethoxysilane, N-cyclohexylaminomethyltrimethoxysilane, methacryloyloxymethyltrimethoxysilane, O-methylcarbamatomethyltrimethoxysilane, and the corresponding compounds in which all the methoxy groups have been replaced either by ethoxy groups or by propoxy groups, in other words, for example, methyltriethoxysilane, and so on. Examples of tetraalkoxysilanes are tetramethoxysilane, tetraethoxysilane, tetra-n-propoxysilane, and tetra-n-butoxysilane. For preparing the siloxane comprising alkoxy groups it is also possible to use mixtures of these tri- and/or tetraalkoxysilanes.

In addition it is also possible, besides these, for monoalkoxysilanes and/or dialkoxysilanes to be used for preparing the siloxane comprising alkoxy groups, as well. Examples are trimethylmethoxysilane, triethylmethoxysilane, triphenylmethoxysilane, dimethyldimethoxysilane, diethyldimethoxysilane, and diphenyldimethoxysilane, and the corresponding silanes in which all the methoxy groups have been replaced either by ethoxy groups or propoxy groups. The monoalkoxysilanes and/or dialkoxysilanes may be used, for example, in order to adjust the degree of condensation or the branching of the siloxane formed.

Preferred tri- or tetraalkoxysilanes used for preparing the siloxane comprising alkoxy groups are methyltrimethoxysilane, methyltriethoxysilane, vinyltrimethoxysilane, vinyltriethoxysilane, n-propyltrimethoxysilane, n-propyltriethoxysilane, phenyltrimethoxysilane, phenyltriethoxysilane, 2-aminoethyl-3-aminopropyltrimethoxysilane, 2-aminoethyl-3-aminopropyltriethoxysilane, 3-glycidyloxypropyltrimethoxysilane, 3-glycidyloxypropyltriethoxysilane, 3-mercaptopropyltrimethoxysilane, 3-mercaptopropyltriethoxysilane, tetraethoxysilane, tetramethoxysilane, and mixtures thereof.

The siloxane comprising alkoxy groups may be formed only from alkoxysilanes of the formula (II) with q=0, with X being preferably methoxy or ethoxy.

The siloxane comprising alkoxy groups is preferably prepared using at least one alkoxysilane of the formula (II) with q=1. In this case the siloxane comprising alkoxy groups, preferably the siloxane comprising methoxy or ethoxy groups, has one or more nonhydrolyzable monovalent hydrocarbon radicals which are bonded to an Si atom and which optionally have one or more functional groups. These nonhydrolyzable hydrocarbon radicals are more preferably methyl, vinyl, n-propyl, phenyl, 2-aminoethyl-3-aminopropyl, 3-glycidyloxypropyl and mercaptopropyl.

The number of nonhydrolyzable monovalent hydrocarbon radicals which optionally have one or more functional groups in the siloxane comprising alkoxy groups may be at least 1, more preferably at least 2, and very preferably at least 4.

The siloxane comprising alkoxy groups that is used in accordance with the invention preferably has one or more nonhydrolyzable monovalent hydrocarbon radicals which are bonded to an Si atom and which optionally have one or more functional groups, has, in which case the nonhydrolyzable radical is preferably methyl, vinyl, n-propyl, phenyl, 2-aminoethyl-3-aminopropyl, 3-glycidyloxypropyl, and mercaptopropyl.

The siloxane comprising alkoxy groups may be linear, cyclic, or three-dimensionally branched. Preferably it is an oligomeric siloxane comprising alkoxy groups.

The degree of condensation pertains to the number of monomeric alkoxysilanes in the siloxane that are condensed with one another, and may also be referred to as the degree of polymerization. The average degree of condensation of the siloxane comprising alkoxy groups is at least 5, more preferably at least 6, and very preferably at least 7. The average degree of condensation of the siloxane comprising alkoxy groups may vary within wide ranges, depending on end use, and may preferably amount, for example, to not more than 15 and more preferably to not more than 12. It is understandable that the degree of condensation, particularly in the case of relatively high degrees of condensation, often represents an average value; generally speaking, in other words, the siloxane constitutes a mixture of compounds with different degrees of condensation.

The average degree of condensation is understood here to be the average degree of condensation based on the numerical average. This numerical average may be determined, as the person skilled in the art is aware, by subjecting the siloxane to measurement by ²⁹Si-NMR spectroscopy and evaluating the spectrum obtained. The measurement and determination may take place in accordance with the details from J. Zhang et al, J Sol-Gel Sci Technol, 2010, 56, 197-202.

Siloxanes comprising alkoxy groups of this kind, more particularly oligomeric siloxanes comprising alkoxy groups, are known and are available commercially, examples being Dynasylan®40, Dynasylan® 1146, and Dynasylan® 6490 from Evonik Degussa GmbH.

The siloxane comprising alkoxy groups is preferably free from oxime groups. The crosslinkable polydiorganosiloxane as well is preferably free from oxime groups. Oxime groups include aldoximo groups and ketoximo groups. Such oxime groups are commonly present, according to the prior art, in the crosslinker of one-pack moisture-curing silicone formulations when there is a desire to accelerate the curing by addition of water. As explained above, where these oxime groups are present, oximes are emitted in the course of curing, and have an unpleasant odor. One advantage of the present invention is that of providing one-pack moisture-curing silicone formulations which cure with acceleration through addition of water and at the same time avoid the release of oximes.

Component A) further comprises one or more condensation catalysts. These catalysts serve to catalyze the condensation and/or crosslinking taking place between the crosslinkable polydiorganosiloxane and the crosslinker in the presence of moisture or water.

The condensation catalyst may be any customary catalyst used for these systems, and is preferably a metal catalyst. Metal catalysts may be compounds or complexes of elements of main groups I, II, IV and V and also of transition groups I, II, IV, VII and VIII of the Periodic Table of the Elements. The condensation catalyst is preferably an organotin compound or a titanate and/or organotitanate. They are available commercially. It is also possible, and in certain cases, indeed, is preferred, for mixtures of different catalysts to be used.

Preferred organotin compounds are dialkyltin compounds, selected for example from dimethyltin di-2-ethylhexanoate, dimethyltin dilaurate, di-n-butyltin diacetate, di-n-butyltin di-2-ethylhexanoate, di-n-butyltin dicaprylate, di-n-butyltin di-2,2-dimethyloctanoate, di-n-butyltin dilaurate, di-n-butyltin distearate, di-n-butyltin dimaleinate, di-n-butyltin dioleate, di-n-octyltin di-2-ethylhexanoate, di-n-octyltin di-2,2-dimethyloctanoate, di-n-octyltin dimaleinate, di-n-octyltin dilaurate, di-n-butyltin oxide, and di-n-octyltin oxide.

Titanates and/or organotitanates are terms used for compounds which have at least one ligand bonded to the titanium atom via an oxygen atom. Examples of suitable ligands bonded to the titanium atom via an oxygen-titanium bond here are those selected from an alkoxy group, sulfonate group, carboxylate group, dialkyl phosphate group, dialkyl pyrophosphate group, and acetylacetonate group. Preferred titanates are, for example, tetrabutyl or tetraisopropyl titanate. Titanates additionally suitable have at least one multidentate ligand, also called chelate ligand. The multidentate ligand is more particularly a bidentate ligand.

Suitable titanates are available commercially, for example, under the trade names Tyzor® AA-105, PITA, TnBT, TPT, TOT, IAM, and IBAY from Dorf Ketal, India.

The fractions of the above-elucidated constituents in component A) may vary within wide ranges. For example, component A) may comprise 25 to 60 wt % of crosslinkable polydiorganosiloxane, more particularly OH-terminated polydiorganosiloxane, 0.1 to 20 wt %, preferably 0.1 to 10 wt %, and more preferably 0.1 to 6 wt % of siloxane comprising alkoxy groups, as crosslinker, and/or 0.001 to 4 wt %, preferably 0.01 to 1 wt %, of condensation catalyst, more particularly Sn and/or Ti catalyst. The quantity figures are based on the total weight of component A).

Component A) may optionally further comprise other constituents, of the kind customary for one-pack moisture-curing silicone formulations. Examples of such additional constituents are plasticizers, inorganic and/or organic fillers, odorants, wetting assistants, pigments, adhesion promoters, processing aids, rheological modifiers, stabilizers, dyes, inhibitors, heat stabilizers, antistats, flame retardants, biocides, waxes, flow control agents, and thixotropic agents.

Preferably the silicone formulation has optionally one or more fillers. The fillers may, for example, influence both rheological properties of the uncured formulation and also the mechanical properties and the surface nature of the cured formulation. It may be of advantage to use a mixture of different fillers.

Component A) may comprise, for example, 10 to 70 wt %, preferably 10 to 50 wt %, of fillers.

Examples of suitable fillers are inorganic or organic fillers, such as natural, ground, or precipitated calcium carbonates or chalks, which are optionally surface-treated, with fatty acids, for example, and silicas, especially fumed silicas, aluminum hydroxides such as aluminum trihydroxide, carbon black, especially industrial carbon blacks, barium sulfate, dolomite, siliceous earths, kaolin, hollow spheres, quartz, calcined aluminum oxides, aluminum silicates, magnesium aluminum silicates, zirconium silicates, finely ground cristobalite, diatomaceous earth, mica, titanium oxides, zirconium oxides, gypsum, graphite, carbon fibers, zeolites, or glass fibers, the surface thereof being optionally treated with a hydrophobizing agent.

Component A) preferably contains no precipitated silica, since the latter adversely affects the storage stability of the composition.

An example of plasticizers for optional use are trialkylsilyl-terminated polydimethylsiloxanes, with the trialkylsilyl-terminated polydimethylsiloxanes preferably having a viscosity at 23° C. in the range from 1 to 10000 mPa·s. Use may also be made, for example, of trimethylsilyl-terminated polydimethylsiloxanes in which some of the methyl groups have been replaced by other organic groups such as, for example, phenyl, vinyl, or trifluoropropyl groups. The polydimethylsiloxane may also be monofunctional, meaning that one end is reactive, via a hydroxyl end group, for example. Certain hydrocarbons may likewise be used as plasticizers.

The constituents of component A) may be mixed with one another in a customary way, with the aid, for example, of a suitable mixing assembly such as a forced mixer or planetary mixer, for example.

The two-pack composition comprises as component B) an accelerator comprising water, with the accelerator comprising preferably at least 15 wt %, more preferably at least 20 wt %, and very preferably at least 30 wt % of water. The accelerator may also consist only of water or may consist substantially of water. Component B) may, for example, include up to 100 wt % and preferably up to 60 wt % of water. In one useful embodiment, component B) may have a water content, for example, in the range from 20 to 50 wt %. The quantity figures are based in each case on the total weight of component B).

Component B) may be fluid or pastelike in consistency. It is preferably an aqueous dispersion.

Component B) may optionally comprise at least one additive selected from an emulsifier, a thickener, a filler, and at least one carrier material selected from a polydiorganosiloxane and a plasticizer. Component B) preferably comprises at least one emulsifier, at least one thickener, at least one filler, and at least one carrier material selected from a polydiorganosiloxane and a plasticizer.

The polydiorganosiloxane may, for example, be a polydiorganosiloxane of the following formula

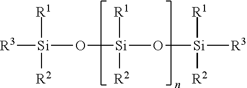

The radicals R¹ and R² here independently of one another are linear or branched, monovalent hydrocarbon radicals having 1 to 12 C atoms, which optionally have one or more heteroatoms, and optionally have one or more C—C multiple bonds and/or optionally have cycloaliphatic and/or aromatic moieties. The radicals R¹ and R² independently of one another are preferably C₁-C₆ alkyl, preferably methyl.

The radicals R³ independently of one another are hydroxyl groups or are linear or branched, monovalent hydrocarbon radicals having 1 to 12 C atoms, which optionally have one or more heteroatoms, and optionally have one or more C—C multiple bonds, and/or optionally have cycloaliphatic and/or aromatic moieties. The radicals R³ are preferably radicals selected from the group consisting of hydroxyl groups, methyl groups, ethyl groups, vinyl groups, and phenyl groups. Most preferably the radicals R³ are hydroxyl groups, meaning that the polydiorganosiloxane is a reactive carrier material.

Furthermore, the index n is selected such that the polydiorganosiloxane at a temperature of 23° C. has a viscosity of 1 to 500000 mPa·s, more particularly 100 to 200000 mPa·s.

Particularly suitable plasticizers for component B) are plasticizers of the kind that may also be included in the one-pack, moisture-curing silicone composition comprising component A) and that have already been described above. Additionally suitable, for example, are esters of organic carboxylic acids or their anhydrides, such as phthalates, as for example dioctyl phthalate, diisononyl phthalate, or diisodecyl phthalate, adipates, as for example dioctyl adipate, azelates and sebacates, polyols, as for example polyoxyalkylene polyols or polyester polyols, polyetheramines, organic phosphoric and sulfonic esters, polybutenes, or blocked polyurethane polymers.

Examples of suitable thickeners in component B) are water-soluble and/or water-soluble polymers or inorganic thickeners. Examples of organic natural thickeners are agar agar, carrageenan, tragacanth, gum arabic, alginates, pectins, polysaccharides, guar flour, starch, dextrins, gelatin, or casein. Examples of organic fully synthetic or semisynthetic thickeners are carboxymethylcellulose, cellulose ethers, hydroxyethylcellulose, hydroxypropylcellulose, poly(meth)acrylic acid derivatives, poly(meth)acrylates, polyvinyl ethers, polyvinyl alcohol, polyamides, or polyimines. Examples of inorganic thickeners are polysilicic acids, finely divided, fumed, hydrophilic silicas, and clay minerals such as montmorillonite.

Examples of suitable fillers of component B) include those which may also be present in the one-pack, moisture-curing silicone composition from component A), and which have already been described above. The filler present in component B) is preferably a filler which has a thickener action and binds water. Most preferably the filler in component B) is selected from the group consisting of silicas, more particularly fumed silica, zeolites, and calcium carbonates, with component B) preferably containing no precipitated silica.

Component B) may further optionally comprise at least one emulsifier. The emulsifier may for example be an anionic, cationic, nonionic, or amphoteric surfactant. Optionally, component B) additionally comprises further auxiliaries such as, for example, thixotropic agents, dispersants, fungicides, or stabilizers.

The ratio of component A) to component B) is preferably 100:1 to 100:10, more preferably 100:2 to 100:5.

The two-component composition of the invention may be used as an adhesive or sealant in a method for adhesively bonding or joining substrates, and enables accelerated curing of the adhesive or sealant. The method of the invention comprises
a) the incorporation of component B) into component A) by mixing, to give a mixture,
b) the application of the mixture to a substrate and contacting of the mixture applied to the substrate with a further substrate, to give an adhesive bond between the substrates, or
   the introduction of the mixture into a gap between two substrates, in order to obtain a joint between the substrates, and
c) the curing of the mixture,

the incorporation by mixing of step a) being carried out before or during the application or introduction of step b).

The components are held separately from one another for storage. The mixing of components A) and B) in step a) may take place in a customary way, as for example by stirred incorporation of component B) into component A), an operation which may take place manually or with the aid of a suitable stirring apparatus, as for example with a static mixer, dynamic mixer, Speedmixer, or dissolver, etc. For application or introduction, furthermore, the two components may be expressed from the separate holding containers, using gear pumps, for example, and mixed. This mixing may take place, for example, in feed lines or nozzles for the application or introduction, or may take place directly on the substrate or in the gap.

The incorporation by mixing as per step a) may therefore is carried out before or during the application or introduction as per step b). Mixing ought to take place a relatively short time before further processing, since mixing is accompanied by the start of curing.

Application to a substrate or introduction into a gap between substrates as per step b) may take place in a customary way, as for example by hand or in an automated operation with the aid of robots. In the case of adhesive bonding, the substrate provided with the mixture is contacted with a further substrate, optionally under pressure, in order to produce an adhesive bond between the substrates. After this, in step c), the mixture is left to cure, commonly at room temperature, in order to achieve the adhesive bonding or joining of the substrates. In this way the adhesively bonded or joined substrates of the invention are obtained, with the cured mixture composed of components A) and B) as adhesive or sealing material.

The substrates to be adhesively bonded or joined may consist of the same material or of a different material. All customary materials may be adhesively bonded or joined with the two-pack composition of the invention. Preferred materials for adhesively bonding or joining are glass, metals, such as, aluminum, copper, steel, or stainless steel, for example, concrete, mortar, building stones, such as sandstone and lime sandstone, for example, asphalt, bitumen, plastics, such as, for example, polyolefins, PVC, Tedlar, PET, polyamide, polycarbonate, polystyrene, or polyacrylate, and composite materials such as CRP.

The two-pack composition of the invention may therefore be used as adhesive or sealant, in the sectors, for example, of construction, sanitary, automotive, solar engineering, wind power engineering, white goods, architectural facings construction and window construction, electronics, and boat- and shipbuilding.

### EXAMPLES

Set out below are specific embodiments of the invention which are, however, not intended to restrict the scope of the invention. Unless otherwise indicated, figures relate to weight. All tests were conducted at 23° C. and 50% rh (relative humidity).

The quantitative fractions reported in the tables below for the constituents of component A), based on the total weight of component A), were weighed out and mixed, with application of reduced pressure, on a Hauschild Speedmixer at 23° C. and 50% rh for 20 s at 2000 rpm. The mixtures obtained were stored at 23° C. under airtight closure.

Employed as component B) were commercial products of Sika Schweiz AG, namely PowerCure Accelerator® (PowerCure), with a water content of about 20%, and Booster 35W, with a water content of about 35% (Booster).

In a first experiment, component A) as a reference was applied on its own (comparative). In a further experiment, the respective component A) was mixed with a component B), with application of reduced pressure, using a Hauschild Speedmixer at 23° C. and 50% rh for 20 s at 2000 rpm, with the fraction of component B) amounting in each case to 4 wt % of the total weight of the mixture. Immediately after mixing, the mixture obtained was used for the tests.

For the purpose of determining the skinover times (SOT), the mixture under test was coated out in a thickness of about 1 cm over an area of about 20 cm². Care was taken to ensure that the surface was smooth. The instant of coating out marked the beginning of measurement. Using a PE and Pipette, the surface of the hardening mixture was contacted. The skinover time was reached when the PE Pipette could be removed without visible sticking.

For the purpose of determining the through-cure time, a Teflon wedge was filled, starting from the deep end, with the mixture under test. The surface was smoothed off using a spatula. Through-cure was tested by drawing out the hardened mixture from the flat end of the wedge until sticking was visible on the bottom and/or walls of the wedge. A determination was made of the time needed to achieve through-curing to a depth of 10 mm.

The determination of the Shore A hardness was made at the times indicated, on a Bareiss Shore A testing instrument in accordance with DIN ISO 7619-1. For the purpose of determination of the Shore A hardness, circular test specimens were produced with a diameter of 42 mm and a thickness of 6 mm.

Tensile strengths and elongations of break were determined in accordance with ISO 37 on S2 dumbbells using a Z010 tensile testing machine from Zwick. For this purpose the mixtures were knife coated to form sheets 2 mm in thickness, and were cured for seven days at 23° C. and 50% rh.

The chemicals used can be taken from the following table.

| Designation | Description |
|---|---|
| OH-PDMS | α,ω-Bis-OH-poly(dimethylsiloxane) with a viscosity of |
| | 20,000 mPas at 23° C. |
| MeO₂MeSi- | α,ω-Bis(dimethoxymethylsilyl)-poly(dimethylsiloxane) |
| PDMS | with a viscosity of 50,000 mPas at 23° C. |
| PDMS 100 | α,ω-Bis(trimethylsilyl)-poly(dimethylsiloxane) |
| | with a viscosity of 100 mPas at 23° C. |
| Chalk 1 | Untreated, ground chalk with a BET surface area of 5 m²/g |
| Chalk 2 | Hydrophobized precipitated chalk with a BET surface |
| | area of 15-24 m²/g |
| Silica 1 | Hydrophilic pyrogenic silica with a BET surface area of |
| | 150 m²/g |
| Silica 2 | Hydrophobic pyrogenic silica with a BET surface area of |
| | 150 m²/g |
| Carbon black | Industrial carbon black with a BET surface area of 84 m²/g |
| Additive | EO-PO block copolymer with 40% EO fraction |
| Crosslinker | Alkoxysilane or alkoxysiloxane, as indicated in the |
| | respective examples |
| Catalyst 1 | Reaction product of dibutyltin oxide and tetraethoxysilane |
| Catalyst 2 | Diisobutoxy bis(ethylacetoacetato)titanate |

The tables which follow contain overviews of the results.

| | Ex. 1 | | | Ex. 4 | | Ex. 6 | Ex. 7 |
|---|---|---|---|---|---|---|---|
| | (Comp.) | Ex. 2 | Ex. 3 | (Comp.) | Ex. 5 | (Comp.) | (Comp.) |
| Component A)* | | | | | | | |
| OH-PDMS | 35.5% | 35.5% | 35.5% | 35.5% | 35.5% | 35.5% | 35.5% |
| PDMS | 5.1% | 5.1% | 5.1% | 5.1% | 5.1% | 5.1% | 5.1% |
| Chalk | 48.6% | 48.6% | 48.6% | 48.6% | 48.6% | 48.6% | 48.6% |
| Silica | 2.5% | 2.5% | 2.5% | 2.5% | 2.5% | 2.5% | 2.5% |
| Carbon black | 1.3% | 1.3% | 1.3% | 1.3% | 1.3% | 1.3% | 1.3% |
| Additive | 2% | 2% | 2% | 2% | 2% | 2% | 2% |
| Crosslinker | | | | | | | |
| 6490^{a)} | 4.8% | 4.8% | 4.8% | | | | |
| 40^{b)} | | | | 4.8% | 4.8% | | |
| VTMO^{c)} | | | | | | 4.8% | 4.8% |
| Catalyst 1 | 0.2% | 0.2% | 0.2% | 0.2% | 0.2% | 0.2% | 0.2% |
| Component B)** | | | | | | | |
| PowerCure^{e)} | | 4% | | | 4% | | 4% |
| Booster^{d)} | | | 4% | | | | |
| Results | | | | | | | |
| SOT | 41 min | 12 min | 7 min | 94 min | 30 min | 30 min | 32 min |
| Through-cure in the | 6 d | 2.5 h | 2 h | 6 d | 2.5 h | 6 d | >7 d |
| wedge (10 mm) | | | | | | | |
| Shore A (3 h) | 0 | 5 | 12 | 0 | 0 | 0 | 1 |
| Shore A (24 h) | 18 | 25 | 31 | 30 | 20 | 15 | 17 |
| Shore A (3 d) | 36 | 32 | 35 | 35 | 35 | 22 | 25 |
| Tensile strength | 1.18 MPa | 1.03 MPa | 1.05 MPa | 1.11 MPa | 1.08 MPa | 1.13 MPa | 0.91 MPa |
| Elongation at break | 319% | 374% | 382% | 330% | 343% | 340% | 351% |

| | Example 8 | | | | |
|---|---|---|---|---|---|
| | (Comp.) | | Example 9 | Example 10 | |
| Component A)* | | | | | |
| MeO₂MeSi-PDMS | 34.4% | | 34.4% | 34.4% | |
| PDMS 100 | 17% | | 17% | 17% | |
| Chalk 1 | 32% | | 32% | 32% | |
| Chalk 2 | 4% | | 4% | 4% | |
| Silica 2 | 8.2% | | 8.2% | 8.2% | |
| Carbon black | 1.3% | | 1.3% | 1.3% | |
| Crosslinker | | | | | |
| VTMO^{c)} | 1.7% | | 1.7% | | |
| 6490^{a)} | | | | 1.7% | |
| Catalyst 2 | 1.4% | | 1.4% | 1.4% | |
| Component B)** | | | | | |
| PowerCure^{e)} | | | 4% | 4% | |
| Results | | | | | |
| SOT | 45 | min | No curing | 15 | min |
| Through-cure in | 4 | d | No curing | 6 | h |
| the wedge (10 mm) | | | | | |
| Shore A (3 h) | 0 | | No curing | 3 | |
| Shore A (24 h) | 0 | | No curing | 18 | |
| Shore A (3 d) | 35 | | No curing | 33 | |
| Tensile strength | 2.2 | MPa | No curing | 2.06 | MPa |

| | | | |
|---|---|---|---|
| Elongation at break | 450% | No curing | 485% |

a) 6490=Dynasylan® 6490 from Evonik, oligomeric silane containing vinyl and methoxy groups *Figure in weight per cent, based on the total weight of component A)**Figure in weight per cent, based on the total weight of the mixture of components A) and B)

b) 40=Dynasylan® 40 from Evonik, siloxane containing ethoxy groups, condensation product based on tetraethoxysilane

c) VTMO=Dynasylan® VTMO from Evonik, monomeric vinyltrimethoxysilane

d) Booster=Booster 35W from Sika AG

e) Power Cure=PowerCure Accelerator(r) from Sika AG

1. A two-pack composition comprising
as component A) a one-pack moisture-curing silicone composition comprising
a) at least one crosslinkable polydiorganosiloxane,
b) at least one siloxane comprising alkoxy groups, as crosslinker, obtainable from the partial hydrolysis and condensation of one or more alkoxysilanes, at least one alkoxysilane being a trialkoxysilane or a tetraalkoxysilane, and the average degree of condensation of the siloxane comprising alkoxy groups being at least 5, and
c) at least one condensation catalyst,
and as component B) an accelerator comprising water.

2. The two-pack composition as claimed in claim 1, the siloxane comprising alkoxy groups and optionally the crosslinkable polydiorganosiloxane being free from oxime groups.

3. The two-pack composition as claimed in claim 1, the siloxane comprising alkoxy groups being obtainable from the partial hydrolysis and condensation of one or more alkoxysilanes of the formula (II)
RqSiX4-q (II)
in which R independently at each occurrence is a nonhydrolyzable monovalent hydrocarbon radical which optionally has one or more functional groups, X independently at each occurrence is an alkoxy group, and q is 0, 1, 2 or 3, at least one alkoxysilane being an alkoxysilane of the formula (II) with q=0 or 1.

4. The two-pack composition as claimed in claim 3, at least one alkoxysilane being an alkoxysilane of the formula (II) with q=1, R independently at each occurrence being a nonhydrolyzable monovalent hydrocarbon radical which optionally has one or more functional groups, preferably methyl, n-propyl, vinyl, phenyl, 2-aminoethyl-3-aminopropyl, 3-glycidyloxypropyl, or 3-mercaptopropyl, and/or X being C1-C6 alkoxy, preferably methoxy, ethoxy, or propoxy.

5. The two-pack composition as claimed in claim 1, the siloxane comprising alkoxy groups being present in an amount of 0.1 to 20 wt %, preferably 0.1 to 10 wt %, in component A).

6. The two-pack composition as claimed in claim 1, the crosslinkable polydiorganosiloxane having hydroxyl groups or masked hydroxyl groups, preferably alkoxy or acetoxy groups, which are bonded to an Si atom and are preferably disposed terminally, the polydiorganosiloxane preferably being a linear polydimethylsiloxane.

7. The two-pack composition as claimed in claim 1, the polydiorganosiloxane being a linear polydiorganosiloxane, preferably a polydiorganosiloxane of the formula (I) 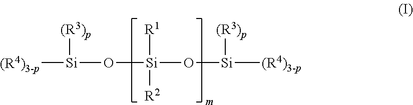
in which the radicals R1, R2 and R3 independently of one another are linear or branched, monovalent hydrocarbon radicals having 1 to 12 C atoms, which optionally have one or more heteroatoms, and optionally have one or more C—C multiple bonds and/or optionally have cycloaliphatic and/or aromatic moieties;
R4 independently at each occurrence is a hydroxyl group or a blocked hydroxyl group, preferably an alkoxy group or acetoxy group, R4 preferably being an alkoxy group;
the index p is a value of 0, 1 or 2; and
the index m is selected such that at a temperature of 23° C. the polydiorganosiloxane has a viscosity of 10 to 500000 mPa·s.

8. The two-pack composition as claimed in claim 1, the polydiorganosiloxane being an OH-terminated alkoxy-terminated, or acetoxy-terminated polydiorganosiloxane, more particularly an alkoxy-terminated polydimethylsiloxane, which preferably at a temperature of 23° C. has a viscosity of 10 to 500000 mPa·s, more particularly of 5000 to 400000 mPa·s.

9. The two-pack composition as claimed in claim 1, component B) comprising at least 15 wt %, preferably at least 20 wt %, of water.

10. The two-pack composition as claimed in claim 1, component B) being an aqueous dispersion.

11. The two-pack composition as claimed in claim 1, component B) comprising at least one additive selected from an emulsifier, a thickener, a filler, and at least one carrier material selected from a polydiorganosiloxane and a plasticizer, component B) preferably comprising at least one emulsifier, at least one thickener, at least one filler, and at least one carrier material selected from a polydiorganosiloxane and a plasticizer.

12. A method for adhesively bonding or joining substrates with a two-pack composition as claimed in claim 1, comprising
a) the incorporation of component B) into component A) by mixing, to give a mixture,
b) the application of the mixture to a substrate and contacting of the mixture applied to the substrate with a further substrate, to give an adhesive bond between the substrates, or the introduction of the mixture into a gap between two substrates, in order to obtain a joint between the substrates, and
c) the curing of the mixture,
the incorporation by mixing of step a) being carried out before or during the application or introduction of step b).

13. The method for adhesively bonding or joining substrates as claimed in claim 12, the substrates to be adhesively bonded or joined being of the same or a different material, the material being selected preferably from glass, metal, concrete, mortar, building stone, asphalt, bitumen, plastic, or a composite material.

14. Adhesively bonded or joined substrate obtainable by a method as claimed in claim 12.

15. The use of a two-pack composition as claimed in claim 1 as adhesive or sealant, more particularly in the sectors of construction, sanitary, automotive, solar engineering, wind power engineering, white goods, architectural facings construction and window construction, electronics, and boat- and shipbuilding.
